(19) United States
(12) Patent Application Publication
(10) Pub. No.: US 2010/0079585 A1
(43) Pub. Date: Apr. 1, 2010

(54) INTERACTIVE THEATER WITH AUDIENCE PARTICIPATION

(75) Inventors: Edward Allen Nemeth, Hermosa Beach, CA (US); David W. Crawford, Long Beach, CA (US)

Correspondence Address: DISNEY ENTERPRISES, INC.;c/o Marsh Fischmann & Breyfogle LLP, 8055 East Tufts Avenue, Suite 450, Denver, CO, 80237, US

(73) Assignee: DISNEY ENTERPRISES, INC., Burbank, CA (US)

(21) Appl. No.: 12/240,149

(22) Filed: Sep. 29, 2008

(51) Int. Cl. H04N 13/00

(52) U.S. Cl. 348/54; 348/E13.001

(57) ABSTRACT

A method for providing differing image streams to audience members in an interactive theater setting. The method includes positioning optical filters such as shuttered glasses between audience members and a display surface. During a display period, two or more image streams are provided on the display surface with the optical filters operating to transmit a first image stream. The method includes modifying an operating state of a subset of the optical filters during the display period to transmit a second image stream. The image streams may be provided by a set of projectors that operate concurrently to project the image streams upon the display surface such as over the same portion of the surface. Modifying the operating state may be in response to user input from audience members such as manual switching of operating state or channel by the user with a device linked to the filter or glasses.

### BACKGROUND OF THE INVENTION

1. Field of the Invention

The present invention relates, in general, to methods and systems for providing interactive experiences for groups of participants and large audiences, and, more particularly, to systems and methods for providing enhanced audience participation in an interactive theater or similar environment and such audience participation may be used to provide a more responsive game, entertainment, and/or education experience for an audience on a member-by-member basis.

2. Relevant Background

Audience response and participation is used in a wide variety of settings to enhance the experience of the audience members. For example, audience response systems are used in educational settings to capture and measure audience (e.g., student) response to a portion of an education presentation or lecture or to poll the audience to determine if the audience can accurately answer a question (e.g., select the correct choice in a true/false or multiple choice question). In entertainment settings, audience interaction may be used to create an interactive game among the audience members or to alter a show or movie being presented to the audience. Tools may be used such that half the audience controls one game character while the other half of the audience controls another game character such that the audience competes to win the interactive game. In other applications, polling may be used to select which branch in a storyline the audience wishes a video presentation to follow typically with the majority of the audience controlling the show. Audience members have generally enjoyed entertainment, education, and other activities that have included audience participation or interaction, and there is a growing demand to provide more interactive experiences and to improve the responsiveness and individuality of each such show (e.g., to make the response to interaction quicker and more personal to each audience member to ensure they feel as if there action/vote matters and has been considered).

A number of techniques have been developed to try to create interactive experiences that are enjoyable to the audience and that effectively capture audience input. However, providing group interactive experiences including audience-based gaming for large numbers of people has proven to be extremely difficult to implement, especially with successful implementation is measured by audience satisfaction and degree of personalization (e.g., did my action or non-action really matter?). For example, many audience participation systems rely on some form of democratic voting or polling or measuring actions taken by a group with simple majority result (e.g., more than 50 percent) controlling the result. Of course, this may leave almost half of the audience feeling disappointed or ignored. To implement such polling/voting systems, the audience may be provided devices that allow them to select one of several buttons/key pads associated with a yes/no, true/false, or multiple-choice selection.

Alternatively, interactive entertainment systems may provide input or “control” by having the system measure or determine audience actions or movements such as determining whether the audience members are leaning left or right in their seats, determining where on a screen audience members are pointing a device such as a laser pointer, how audience members are moving an object such as a beach ball with the shadow used as a pointer, determining which side of a reflective paddle is facing a screen (e.g., reflective paddles with red on one side and green on the other), determining overall movement of audience members, and the like.

Again, much of the audience may feel they have little or no influence over the results of the interactive experience such as movement of an animated character in an interactive game displayed on a theater display screen. Also, many of these systems require significant amounts of processing such as processing of video streams to determine crowd movement, and there may be a relatively large delay or lag between the audience action or input and a change in the projected image or game action (e.g., feedback from the interactive system). Such delay in response or gratification is often a problem when the desired/selected action is not taken (e.g., crowd leans to the left to choose a particular response but there is a several second delay by which time the crowd is now sitting straight or the like). Such lack of responsiveness may be acceptable in some environments such a classroom application or a crowd waiting for a show to begin, but such a delay in response is seen as a lack of interactivity that is unacceptable in most primary interactive experiences such as an interactive game provided in a theater or similar setting.

Hence, there remains a need for improved methods and systems for providing enhanced interactive experiences to various sized groups (e.g., groups of several members to groups or audiences of hundreds or thousands). Preferably, such methods and systems would support audience participation by increasing each member's perception that their input or interaction affected the system output (e.g., changed a game, altered a displayed video and/or audio stream, and the like) and by providing a highly responsive experience (e.g., providing an experience where feedback, in the form of a change in systems output such as a video display, movement of a character, and so on, is immediate or nearly so).

### SUMMARY OF THE INVENTION

The present invention addresses the above problems by providing methods and systems for providing an interactive theater with enhanced audience participation, e.g., increased responsiveness to user input. In attempting to provide an improved interactive theater, the inventors recognized that technologies presently exist that allow for multiple video or image streams to be broadcast or displayed on a single display or screen. Multiple image streams may be provided by projecting time multiplexed images onto a display screen and then synchronizing shuttered glasses to the time sequence corresponding to the frames displaying the desired image (e.g., the image to be seen at a particular time through the shuttered glasses). Glasses that can shutter at up to 300 Hertz are currently available and can be used to broadcast or project up to at least three separate three dimensional (3D) streams or up to at least six separate two dimensional (2D) streams onto the same screen, and it is likely that the number of streams that may be supported by such a multi-stream projection system will increase as projection and shutter glass technology improves in coming years.

Presently, multiple stream projection is used either to create a 3D effect (e.g., shuttering to control left and right eye images viewed by person wearing the shuttered glasses) or to support multiple players in a video game environment. In the latter application, each player wears shuttered glasses that operate at a frequency such that they view an image stream associated with their player view such that split screen views are not required (e.g., Player A and Player B each wear glasses set to operate at differing frequencies such that they view Player A video stream and Player B video stream, respectively, as it is displayed in an alternating (or time multiplexed fashion) on the entire monitor or television screen). Existing uses may be thought of as operating the projection system and shuttered glasses in a deterministic and fixed manner to provide a desired effect, with the shuttered glasses (or optical filters) operated in a consistent manner throughout a video game or video presentation to achieve the desired 3D effect or time separated 2D effect.

In contrast, the inventors recognized that it would be highly desirable to project multiple video streams on one or more display surfaces and include a new capability to choose which video stream is viewed by audience members, subsets of the members, and even individual members by modifying the optical filters. For example, shuttered glasses may be provided to each of the audience member and two or more video streams projected on a theater screen. The shuttered glasses are modified to include a switching capability that allows them to be operated at two or more operating states (e.g., frequencies, polarization states, or the like) to synchronize shuttering to view any of the projected video streams. In some cases, a guest controlled action or audience member input (“user input”) is used to determine when to switch the shuttered glasses to a different operational state and to allow the audience member wearing the glasses to view a different video stream corresponding to the new operational state. In other cases, the switching may be controlled remotely based on the user input (e.g., audience members that lean left see a different image than those that lean right) or to achieve a desired effect (e.g., switching portions of the audience's optical filters or glasses to view differing streams during the particular event or game). Generally, the switching is immediate upon receipt of user input (or controller commands) to provide improved responsiveness and to increase the audience member's perception that they controlled the displayed image, but, in some cases, the response may be delayed such as to wait until a branch in a storyline or the like.

According to one aspect of the invention, an interactive theater system is provided that includes the capability of determining which one of a number of image streams that are being “concurrently” displayed upon a screen is viewed by an audience member based on a guest controlled action or user input. In this case, concurrent display is intended to apply to any set of video streams that are being projected or otherwise provided upon a single display surface such as movie theater screen for concurrent viewing by an audience (e.g., differing audience members may watch differing video streams during the same time period but not necessarily with each corresponding frame(s) shown simultaneously) such as by time multiplexing the concurrently displayed streams or use of polarization techniques. The capability for guest-directed control over the viewed images provides extremely personal and rewarding interactivity and game play in group and theater environments. For example, guest-determined storytelling can be provided by operations of some embodiments of the invention by giving guests control (such as with an input device to switch operating states of their viewing glasses or optical filter) over which image stream they watch and when they watch it. Such an interactive theater system may be adapted to allow guests or audience members to select one of multiple image streams during the course of the story or event (rather than choosing a setting prior to the start of the event or game) while preserving the fundamental or traditional linear and guided storyline desired for most attractions (e.g., storyline is controlled by selecting/designing set of input video streams concurrently provided for selective viewing) and/or by controlling when the audience member can change image streams via their user input. In many settings, such control and user feedback may give each audience member the impression that they impacted the outcome (or display output) for the entire theater audience. As will be appreciated, such individual user control of which video stream is viewed at least once during the course of the displayed activity, game, show, or event significantly increases the satisfaction and enjoyment of the audience members (e.g., an audience member is able to change the movie or game play shown on the main screen to what they want to see simply by pressing a button or providing other input).

More particularly, a method is provided for providing differing image streams to members of an audience such as participants of a game in an interactive theater setting. The method includes positioning a plurality of optical filters between members of the audience in a viewing area (e.g., a theater) and a display surface (e.g., a movie screen). During a display time period, two or more image streams are provided or displayed upon the display surface with the optical filters operating to transmit a first one of the image streams. The method continues with modifying an operating state of a subset of the optical filters during the display time period to transmit a second, differing one of the image streams. In this manner the members of the audience view two differing image streams. The image streams may be provided by a set of projectors that operate to concurrently (e.g., time multiplexed with shutters or the like) to project the image streams upon the display surface, and the projectors may be adapted to display the images on the entire display surface or at least onto a set of display areas that at least partially overlap each other (e.g., not a split screen effect but instead multiple images projected onto a single surface).

The modifying of the operating state may be performed in response to user input from audience members associated with the subset of optical filters (e.g., the members provided input/actions that were processed by a control system to determine a selection of a particular image stream). The optical filters may be devices worn by each of the audience members, and the user input may involve the wearer/audience member manually switching the operating state by operating a state selector communicatively lined to the worn devices. For example, the devices may be LCD or other shuttered glasses with the switchable operating states corresponding to differing shuttering frequencies that are synchronized with the projection/display of the various image streams on the display surface (e.g., with operation of the projectors) to filter all but one of the streams. The method may further involve providing a cue to the audience to provide the user input and using a controller or control system to enable operation of the optical filters to modify the operating states after or upon issuance of the cue, whereby branching is selectively controlled.

According to another aspect, an interactive theater system is provided that includes a set of projectors such as digital video projectors that operate to project a set of image streams upon a display surface. For example, high frequency shutters may be provided with the projectors and operated such that the projectors may “concurrently” project differing image streams onto a single area or portion of a screen. The system also includes optical filters that are wearable by audience members in an interactive theater, and these filters are operable in at least two operating states to filter all but one of the image streams, whereby the audience members are able to view the one not filtered or blocked image stream (e.g., sets of right and left frames of a video). The theater system may also include operating state controllers associated with each of the optical filters that select one of the operating states for each of the operating filters and, at least once during the projecting, the operating state controllers are independently operable to change which one of the image streams is transmitted through the optical filters or viewable by the audience members. In one embodiment, the optical filters are shuttered glasses that are operable at shuttering frequencies that are selectively synchronized with the image stream projection/transmission frequencies so as to block all but one of the image streams.

In some cases, the operating state controllers are operable by the audience members such as via a channel selector on or nearby the glasses to switch between the shuttering frequencies to allow the audience members to individually be able to select the image stream they view. The operating state controllers may be operable only in response to receipt of a selector enable signal from a system controller (such as may be sent to a subset of the state controllers based on a random selection or selection based on a particular criteria such as user input). In some applications, the system controller may remotely control the switching between operating states so as to cause portions of the audience members to view differing ones of the image streams. In some embodiments of the system, the image streams include video images associated with a common storyline, and each of the image streams includes at least some differing content relative to the other image streams, whereby switching between the images streams allows the audience members to view the differing content such as a branch in a story or to provide an interactive video game to the audience members.

### BRIEF DESCRIPTION OF THE DRAWINGS

FIG. 1 is functional block diagram of an interactive theater system of an embodiment of the invention such as may be used in an entertainment or educational application to allow differing audience members to view differing video streams projected upon a single display surface or screen;

FIG. 2 illustrates schematically management or use of image streams by an interactive system of the invention such as the systems of FIGS. 1 and 3;

FIG. 3 illustrates another functional block diagram similar to FIG. 1 illustrating aspects of an interactive theater system using optical filters adapted to operate in differing operating states to select or filter differing video streams projected upon a display surface or screen;

FIG. 4 is a schematic of another interactive theater system of an embodiment that utilizes LCD shuttered glasses with a user input device with buttons/switches for selecting the shutter rate and, therefore, a particular displayed video stream;

FIGS. 5A-5F illustrate a display with multiple video streams/images displayed “concurrently” upon the display as well as each individual stream that may be viewed by an audience member via an optical filter set to a particular operating state; and

FIGS. 6A-6D illustrate a display surface similar to that of FIGS. 5A-5F used to provide a multiple point of view (POV) storytelling implementation or operation of an interactive theater of the invention.

### DETAILED DESCRIPTION OF THE PREFERRED EMBODIMENTS

Briefly, embodiments of the present invention are directed to methods and systems for providing an interactive theater with enhanced audience participation. The interactive theater systems described herein generally include a projection assembly that operates to project or display two or more image streams upon a display surface (e.g., a theater screen or the like). The interface theater system also includes two or more optical filters that can be operated to select two or more differing operating states or channels such that audience members can be watching each of the two or more displayed video streams. The optical filters may have their operating states controlled or changed by the audience members such as the user providing a type of “user input” such as simply pushing a button or selection mechanism on the filters or on a selector in communication with a filter controller to alter the filter's operating state (e.g., shuttered glasses with a channel selector operable by the user to change channels by changing shutter speed to synchronize with a differing one of the image streams on the display). In other cases, the operating state is changed remotely such as by sensing a user action/movement or user or to provide a desired show effect to change the operating state of one or more of the optical filters to change the image stream during the particular show or event. The interactive theater system also includes a system controller to synchronize operation of the projectors and of the optical filters such as by including a shutter controller for the projectors and synchronizing operation of these shutters with shuttered glasses worn by the audience. The system controller may also transmit selector enable signals to control when audience members may change the operating states of their optical filters and/or transmit channel/state selection signals to remotely alter the optical filters such that at least some of the audience members view differing ones of the displayed image streams.

The interactive theater systems and methods may provide “on demand” experiences where audience members can switch between viewing channels or filter operating states at any time during display of a set of video streams on a display surface. In other cases, the system controller or other devices may operate to only allow switching at particular points in time, and the switching may be manual by the operator or automatically based on user input/actions (e.g., determining when an audience member takes an action such as leaning to the left or right in their chair). In this description, “user input” is considered to cover nearly any action that can be processed or used to choose between various image streams (e.g., a physical action or speech and so on). A significant aspect is that the image streams are typically not altered during an event or display activity such that the users are not changing image streams but, instead, the users or audience members (or the system controller) are changing operation of their corresponding optical filter during the display event or activity such that their viewed image may be considered an individual-selectable video stream. The following description first provides several systems that may be used to provide interactive theater experiences with audience participation/control. The description then discusses several implementations that include audience participation and unique storytelling aspects achievable due to ability to switch the image stream viewed by subsets of the audience using a single (or smaller number) of display surfaces.

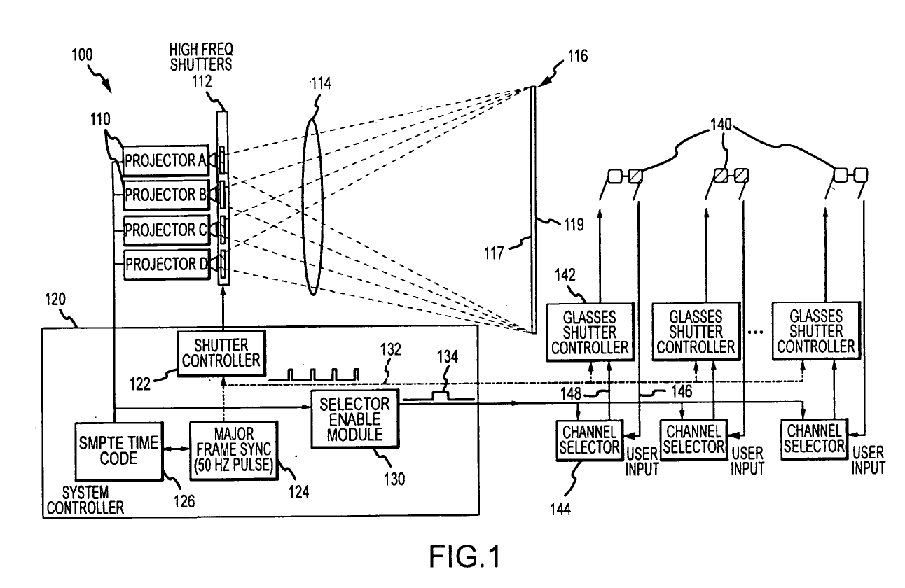

FIG. 1 illustrates an interactive theater system 100 of one embodiment of the invention. As shown, the system includes a projection assembly with a set of four projectors 110 operating to project or display a set of image streams 114. High frequency shutters 112 are provided at the projector outputs to time multiplex the frames of the streams 114 from the projectors 110 as is known in the art for use in creating 3D imagery and providing multiple 2D image streams. In this description, though, these streams are considered to be “concurrently” displayed upon a display screen or device 116 with a rear surface 117 and a front or viewing surface 119 exposed to a plurality of viewers or an audience. These images 114 are considered concurrent as rate or frequency is such that there is no or little perceptible delay of the streams when a viewer switches between the streams. Four projectors 110 are shown but 2 to 6 or more may be used in the projection assembly and the high frequency shutters 112 may operate at a wide range of frequencies to open and close such as 50 to 300 Hertz (Hz) or more.

The system 100 also includes a system controller 120 that includes a time code module 126 for providing a time code signal to the projectors 110 such as an SMPTE time code signal to synchronize their operation to display images 114, and the time code module 126 may be used to generate with a major frame synchronization signal via module 124 such as at 50 Hz or another useful frequency that is used by shutter controller 122 to operate shutters 112. The controller may be set to a particular frame offset, and a synchronization signal (or timing reference pulse) 132 may be transmitted from the controller 120 to synchronize operation of optical filters such as the illustrated glasses 140 used by the audience or this signal/synchronization portion may be provided in streams 114 (e.g., IR embedded in signal and glasses are configured to respond). The system controller 120 may also include a selector enable module 130 to transmit a control signal 134 to limit when audience members may change operation of their optical filters or to remotely change the operating state of the optical filters. For example, the selector enable module 130 may issue the signal 134 during an interactive game provided by system 100 to allow audience members to provide user input to change channels to select one of the image streams 114. Alternatively, the controller 120 may operate the selector enable module 130 to transmit the remote channel changing signal 134 to a subset of the user devices to change the operating state of their optical filters to change the viewed image stream of that subset of the audience.

The system 100 also includes an audience viewing assembly that includes a plurality of optical filters shown as shuttered glasses 140 that are worn by the members of the audiences to view an image stream provided by the projectors 110. A glasses shutter controller 142 is provided for each of the glasses 140, and this controller 142 changes the operating state (e.g., the shuttering frequency of LCD glasses) of the glasses 140 to choose which image stream is viewable (e.g., which others are filtered or shuttered out). The controller 142 operates in response to a channel selection signal 148 from a channel selector 144, which may be a wired or wireless device communicatively linked to the controller 142. The channel selector 144 may be operable remotely via signal 134 from selector enable module 130 (e.g., based on processing/interpretation of user input 146 or a show control program or the like) and/or based on direct user input 146 (e.g., a person wearing glasses 140 may press a button on the selector 144 to choose a channel or image stream 114 to view). As shown, the glasses 140 are in three differing operating states allowing audience members wearing the glasses to view three differing image streams concurrently, and, as noted above, the channel selector is operated during operating of the projectors 110 to change image streams during a display event or activity, which can achieve an interactive game effect, support storytelling, and/or other desired audience participation effects. While 3 different states are shown, the active state of the glasses can tune into any of the 4 differing image streams.

As noted, the glasses 140 may be liquid crystal display (LCD) shutter glasses that are configured with glass lenses with liquid crystal and a polarizing filter that has the property that it becomes dark when voltage is applied but otherwise is transparent. A pair of eyeglasses can be made using this material and then operated by the glasses shutter controller to alternately darken one eye or lens and then the other in synchronization with signal 132 to view a particular image in the streams 114 such as to view a 3D display with the left and right eye images being alternated rapidly by projection shutters 112. When the viewer looks at the screen surface 119 through the shuttered eyewear, each shutter is synchronized to occlude the unwanted image and transmit the wanted image such that each eye sees only its appropriate perspective view (left or right eye image). For example, the glasses 140 may be operable to shutter at up to 300 Hz to allow at least 3 separate 3D streams or 6 separate 2D streams to be broadcast onto the screen 116 and selectively viewed by the wearers of the glasses 140.

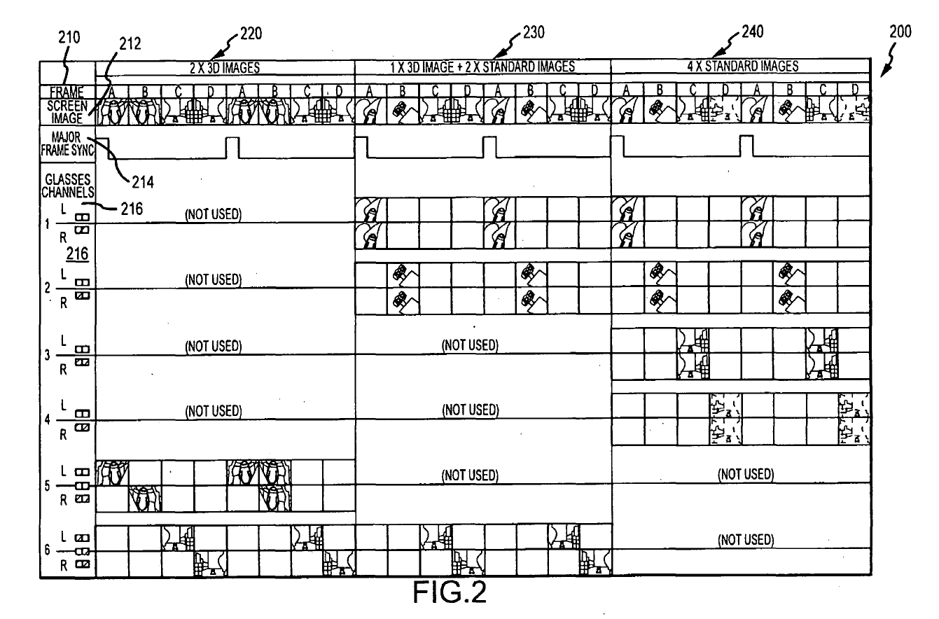

This can be seen in FIG. 2 in which the system 100 may be used to support a plurality of viewed image streams or glasses channels used to view or filter these streams. As shown, the projectors 110 provide four images streams shown by frames 210 (labeled frames A, B, C, D associated with each projector 110). These “concurrently” (e.g., with very small time separations or multiplexing)) project and display on screen 116 images 212. The glasses 140 may be operated with shutter controller 142 (in response to signals 148 from channel selector 144) to a set of glasses channels 216 (numbered 1-6), and, typically, operation of the shuttering of glasses is synchronized with a signal from a system controller or projection system such as a major frame synchronization signal 214. In this example, four frames are displayed as shown at 210, 212 (i.e., one from each projector 110) in a time multiplexed manner for each major frame sync pulse 214, and then the next frames/screen images are shown at 210, 212.

In operating mode 220, the system 100 is operated such that two 3D images may be selectively viewed by the wearers of the glasses 140 or audience members by choosing channels 216 numbered 5 and 6. In this mode, frame A is provided to the left eye and then frame B is provided to the right eye on a first channel such as may be associated with first pair of the glasses 140 worn by a first member or subset of the audience. Then, for glasses 140 set to channel 6 are synchronized to receive frame C for the left eye or left lens and then frame D for the right eye or right lens. This pattern is repeated for each set of glasses set to channels 5 and 6. For example, a first set or portion of the audience may view a first image stream associated with channel 5 while (concurrently with or substantially concurrently with) a second set or portion of the audience viewing a second image stream associated with channel 6.

In operating mode 230, the audience members may view one 3D image stream and two 2D or standard image streams by choosing one or three channels 216. In operating mode 240 of the projection assembly, the audience members may view four 2D or standard images when the shuttered glasses are set to operate in one of the four channels 216. Again, the switching may be in response to user input (direct operating of a channel selector or more indirect such as the control system determining user input and operating the channel selector) or based on control programs such as to alter or present a storyline with changing image streams for at least some of the audience members. FIG. 2 is useful for illustrating that an interactive image system can readily be operated to display multiple image streams on a single display with frames (e.g., A-D or more) shown on a single display surface, and, then, an optical filter such as LCD shuttered glasses or the like may be selectively operated (e.g., a channel selected) such that they are synchronized so as to received/view one of the displayed image streams. For example, audience members may be able in operating mode 240 to select between 4 standard image streams by providing a predefined user input(s) or in operating mode 230 the control system may be operated to use stored programs/timing of switches and/or process user input (audience movements or yelling or the like) to switch between a 3D image stream and two 2D image streams.

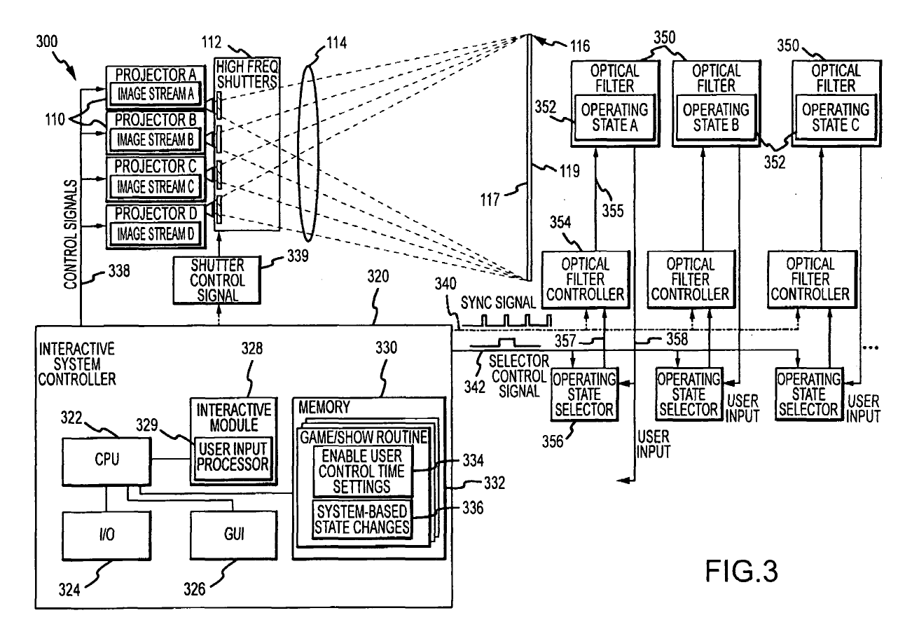

FIG. 3 illustrates another interactive theater system 300 of the invention with a projection assembly similar to that shown in FIG. 1 with four projectors 110, a set of high frequency shutters 112 and a display device 116 used to display image streams 114 (e.g., frames of an animated work, a film, a video game, or the like). The system 300 is shown to include a plurality of optical filters 350 that are used to filter all but one stream from image streams 114 on display 116 such that viewers or audience members on an opposite side of the filters 350 is able to selectively view an image stream in a selective manner. For example, the optical filters may be glasses/goggles or a helmet shield worn by the audience members or may be provided in other forms such as windows that are shared among two to four or more audience members for viewing an image on a display (e.g., a windshield of a vehicle in a theme ride). An important factor being that each filter 350 is adapted for having two or more operating states 352 to affect filtering of all but one image stream from image streams 114 and not necessarily how this filtering is achieved. As noted above, the optical filters 350 may be LCD or other shuttering glasses. In other cases, color filter glasses are used for the filters 350 while polarizing glasses of various configurations may be used for the filters 350. The selection of the optical filters 350 may alter the selection of the projectors 110 and/or media/streams 114 to support the proper operation, filtering, and then viewing of the images.

The optical filters 350 have their operating states 352 set by control signals or operation of optical filter controllers 354, and the operating states 352 may be the same such that the filters 350 operate to pass the same image stream to all audience members. In other cases, as shown, the operating states 352 may differ such that audience members or viewers receive or are shown differing image streams (e.g., as shown, the audience members would be shown 4 differing image streams). The optical filter controller 354 may receive a time synchronization signal 340 from interactive system controller 320 and operates to set the channel or operating state 352 based on an operating state selection signal 357 received or chosen by the system 320 or an operating state selector 356 based upon user input 358.

The interactive system controller 320 may be embodied in a number of computers or electronic devices such as a computer device/server with a CPU 322. The CPU 322 controls user input/output devices 324 and optionally providing a graphical user interface (GUI) 326 on a monitor or the like that allow an operator to manually issue selector control signals 342 to change the operating state 352 of one or more of the optical filters 350. More typically, though, the controller 320 acts to transmit a shutter control signal 339 and a synchronization signal 340 to the filter controllers 354 to allow these devices to work in unison to allow the filters to properly allow one image stream to pass to a viewer at a time (e.g., left and right frames and so on). An interactive module 328 (e.g., a software program or application) may be provided to facilitate audience interaction and, in response, to transmit the selector control signals 342. For example, the module 328 may include user input processor 329 to process user input 358 to determine which operating state 352 to place the filters 350. In one exemplary embodiment, the user input 358 involves the audience members leaning in their chair to the left or right and the input processor 329 determines the lean direction and responsively selects an operating state 352 to choose a corresponding one of the image streams 114.

The controller 320 may also include memory 330 storing a game/show routine 332 that include time settings for transmitting selector control signals 342 to the operating state selectors 356. In one case, when these signals 342 are sent to a set of selectors 356 the associated audience members may provide user input 358 to choose the operating states 352 (e.g., to change the channel to view a differing image stream among concurrently displayed streams 114). In other cases, the game/show routine 332 may be configured to process user input 358 at particular times during transmittal of streams (when control signals 338 are being sent by controllers 320) and then transmit selector control signals 342. For example, audience interaction may be requested by the content of streams 114 such as lean to the left if you want a particular outcome or yell loudly to cause another effect and so on. The user input processor 329 may process this input and, in response or based on such processing, choose a particular image stream and send a corresponding selector control signal 342. In some cases, the game/show routine includes a set of system-based state changes 336 that cause particular selector control signals 342 to be transmitted during operation of the projectors 110 (e.g., during a particular display activity or event such as an interactive game) so as to choose a particular image stream for the audience members (the same or differing image streams for audience members). In this later operating mode, the changes in operating state are not performed in response to user inputs but are performed during the display of a particular set of image streams to cause a change by altering operation of the local optical filters 350 and, typically, to cause the viewing experience to differ for at least some of the audience members.

As discussed above, a problem addressed by embodiments of the present invention is how to better provide group interactive experiences and gaming for large numbers of people. In the past, it has proven especially difficult to provide interactive experiences to groups in a way that felt personal and satisfies each audience member's desire to be heard or treated as if their input were significant. Most prior attempts relied upon some sort of democratic vote/action, which left a large number of the audience disappointed when then were in the minority and their selection was not used/chosen. There also often was a delay in response or gratification as the action chosen by the majority was not taken immediately.

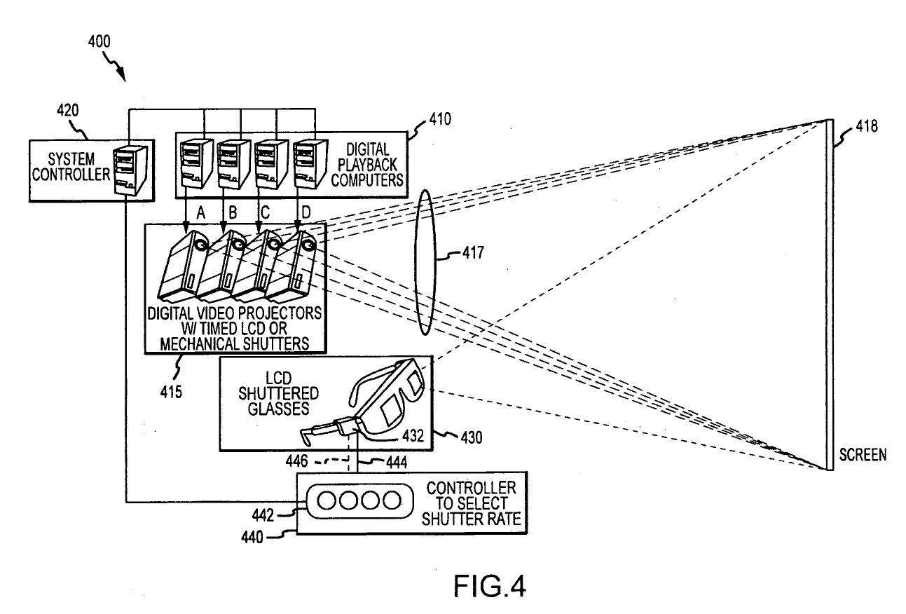

FIG. 4 illustrates one embodiment of an interactive theater system adapted to provide audience members with a more immediate gratification/satisfaction. As shown, the system 400 includes a plurality of digital playback computers 410 that are used to provide a like number of image streams (e.g., streams A, B, C, D which may be frames associated with a left or right eye view) to a set of digital video projectors with timed LCD or mechanical shutters 415. These projectors 415 provide time multiplexed projection of image streams 417 that is capable of multiple views (e.g., two or more image streams that may be made up of paired left and right images or image frames). The images 417 include a number of playback streams that is generally only limited in magnitude by shutter rate technology and these image streams 417 are displayed via the display screen 418 (front projection screen, rear projection screen, or other display surface/device).

Each audience member in the system 400 is provides a pair of LCD shuttered glasses 430 with the number of glasses 430 being unlimited to implement system 400. The LCD shuttered glasses 430 include a shutter controller 432 on the glass frame that is operable to shutter the glasses 430 at a frequency synchronized with one image stream (or with an image viewing channel). A controller 440 may be handheld or mounted upon the audience members chair with buttons/switches/knobs 442 that allow a user to select the shutter rate or choose a viewing channel. In other cases, the channel selector/controller 440 is provided on the glasses frame such as by being mounted as part of shutter controller 432. The controller 440 is hard wired to provide a communication and power supply link to the shutter controller 432 as shown with line(s) 444 or may optionally be wireless linked as shown at 446 with a battery or other power supply provided in or near the glasses frame. A system controller 420 (e.g., another computer device as shown in FIG. 3 or the like) is linked to the playback computers 410 and the shutter rate controller 440 to provide time code and/or frame synchronization pulses to allow synchronized operation of the projectors 415 and shuttered glasses 430.

With the underlying technologies understood, it may now be useful to describe a number of applications or methods of using this on demand channel/image stream switching technology. Changing or switching between image video streams may be used in an interactive theater system may be used to allow individual “guest-determined storytelling” through a variety of interactive and/or gaming experiences that were previously unavailable or not available in a satisfying environment/process. The capability of guests or audience members to control or direct the viewed images provides an extremely personal and rewarding interactivity since the audience members directly and immediately perceive their actions having an impact on what they are seeing. The following provide some useful examples, and with these examples in mind, those skilled in the art will quickly identify additional applications and uses of the enhanced audience participation and/or interaction features of embodiments of the invention.

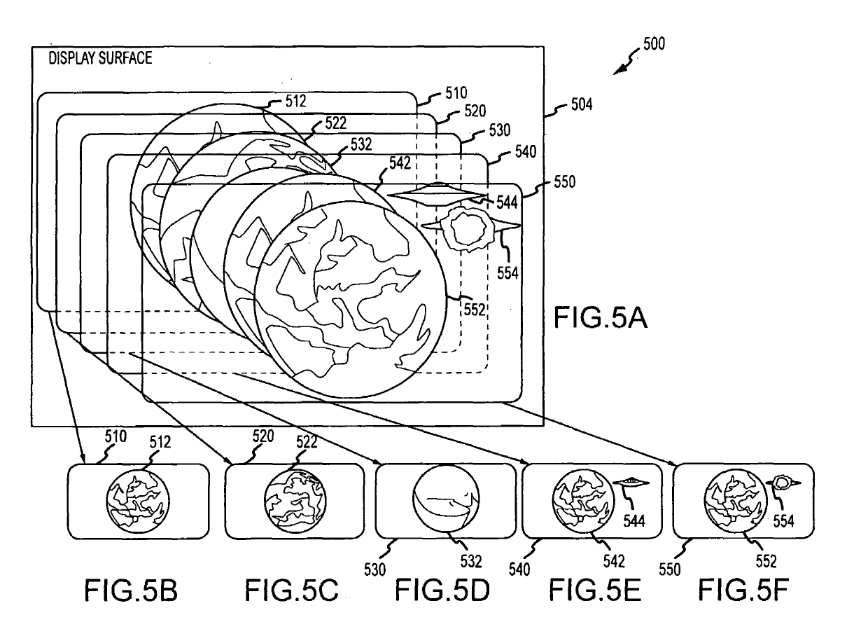

One method of use of an interactive theater system is to provide view switching in gaming and other applications. For example, FIGS. 5A to 5F illustrate view switching in an interactive gaming embodiment of the invention. A shown in FIG. 5A, the display surface 504 is receiving or being used to display 5 differing image streams 510, 520, 530, 540, and 550 in a composite image 500. The image 500 includes 5 video streams 510, 520, 530, 540, and 550 that are broadcast simultaneously or concurrently (as those terms have been explained herein) at differing frequencies or with differing timing. Shuttered glasses or other optical filter devices may be worn or used by audience members or viewers of the image 500 to allow them to individually select the video stream 510, 520, 530, 540, or 550 they are observing (or the glasses may be controlled at least part of the time by the system controller), with only one stream typically being visible at a time via the shuttered glasses.

In an interactive game involving alien invasion, the audience members may all begin with viewing a common image such as a view of the Earth from space 512 as shown in image stream 510 of FIG. 5B, and this is achieved by having all audience members begin a game with their glasses at a first/common channel. The audience members may then be allowed (such as with a channel selection enablement signal from a control system) to being switching the channels of their glasses to view differing image streams. At this time, the audience often and typically will be viewing two or more of the differing image streams 510, 520, 530, 540, and 550 at a particular time during the game (or image stream display or viewing event or activity). For example, an audience member may provide user input (e.g., press a channel change button on their glasses or arm of their seat or on the back of the seat in front of them) to change the view to that shown in FIG. 5C. The image stream 520 may provide a different view of the Earth such as an infrared (IR) view of the Earth to look for a heat signature of a UFO that has landed upon the Earth. If no signature is identified, the audience member may provide user input to select the channel or state of operation for their glasses to view or receive the image stream 530 shown in FIG. 5D, which provides a remote view of the planet Mars 532 (where the aliens and UFO are coming from in this case). If there are no UFOs in sight, the user then may provide additional user input to select a channel providing image stream 540 which is the normal Earth 542 with a UFO 544 nearby. If the user provides proper triggering or other user input (such as by switching to another channel or image stream feed) associated with image stream 550 the Earth 552 is shown with the UFO 554 hit by a guest fired projectile/missile. If the timing or audience participation is not well timed/aimed, the view in FIG. 5E may be continued to be shown or another image stream (with the Earth being attacked) being shown. As will be understood, the experiences of the various audience members will be directly related to the user input they provide and the timing of such input. Hence, the interactive nature and responsiveness of the interactive game may be greatly enhanced with each audience member receiving near immediate feedback for their user input.

The selectable image stream aspects of the invention allow for multiple, differing point of views (POVs) may be providing to vary storytelling. In these applications or operating modes, an audience member may watch a story from one or another POV simply by switching through multiple video streams that are provided concurrently by a projection assembly on a display surface (and each stream may be associated with a differing character). This allows guests to fill in a whole, complex story through multiple viewings and individual stream switch times (e.g., the experience may differ each time the audience member attends a show or takes a ride at a theme park). The streams could be designed to support many special effects and fun gags like watching a character look into a whole and then switching to the character POV to see what is in the hole.

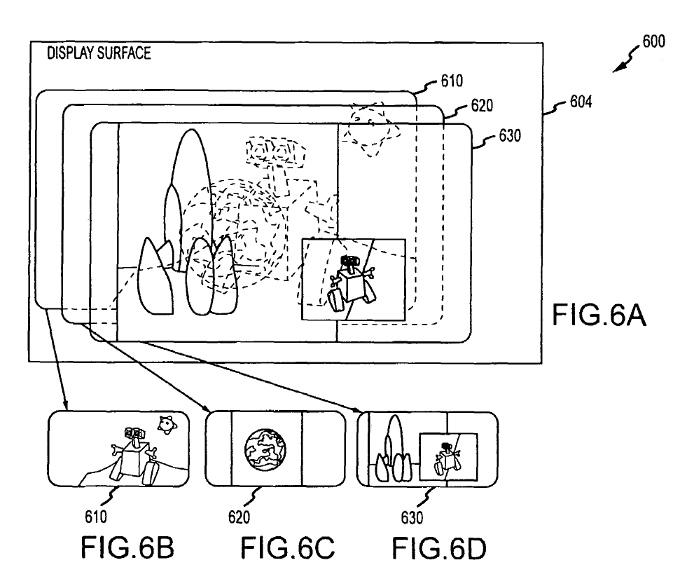

FIG. 6 illustrates a concurrently displayed set of images 600 on a display surface 604 that includes three video streams 610, 620, 630 broadcast simultaneously from a set of projectors. Optical filters such as shuttered glasses worn by each guest may be used and selectively operated (or synched to the projectors) to view one of the video streams 610, 620, 630. This application or operating mode of an interactive theater system may be used to give multiple characters' POVs on a common storyline. For example, the audience member may first choose the image stream 610 shown in FIG. 6B that shows a first view, e.g., a general perspective view of a scene. The audience member may then choose one of the character's views as shown to see video stream 620 as shown in FIG. 6C. Next, the audience member may go back to view 610 or move on to another character's POV as shown with video stream 630 shown in FIG. 6D. The audience member may be able to switch or select channels by providing user input, which may take a number of different forms to practice the invention including simply pressing a button on a channel selection device or moving in a particular manner and so on. Alternatively, the control system may transmit signals that make a subset of the audience view the story from a particular character's POV (e.g., those that indicated at some prior time a desire to be a certain character).

The interactive show would allow creators of shows to build a story based on what each character sees individually but that follows a common storyline to allow switching during the display of the image streams 600 in a coherent and understandable manner (e.g., the story makes sense even after switching and is entertaining along any viewing pattern). For example, an interactive video game may have a 5 minute duration from start to finish, and, during this time, audience members may be able to participate or interact with the game by switching video streams they view multiple times (even though the projectors may in operation be unchanged during the same time period as they simply project a particular feed). In other words, the audience interaction changes video streams at the optical filter such as by changing the operating frequency of LCD shuttered glasses and not at the projectors as was done in many prior interactive devices. Hence, the interactive theater methods described herein are able to engage and interact with each audience member rather than by taking a vote/poll and rewarding those in the majority.

The interactive theaters may provide numerous other interactive and/or gaming experiences in addition to view switching and multiple POVs. For example, visual enhancement of a current view may be provided by switching image streams such as provide a zooming in (magnification) effect, zooming out, X-ray effects, infrared viewing (such as if seeing through night vision goggles and the like), and many more visual alterations of the same scene/image (e.g., same view but differing visions). Similarly, the same scene or view may be altered with a time machine effect that allows the audience to travel in time to view the scene in the past, future, or alternate timeline/dimension simply by providing user input to select a different image stream (or the change may be made by the controller system for a subset of the audience). The same scene or view may also be altered to provide differing versions of a single show/scene such as a version for young children, for teenagers, and for adults, and typically, this switching or branching between streams may be limited or controlled by the control system or, in some cases, audience members may be able to see “younger” rated versions but not older to control viewed content (e.g., avoid showing violence to young children and the like). Certain parts or scenes of a show may also be the same for all audience members with the rating systems only used at particular branches in the storyline (e.g., the first scene may be identical for all audience members, the second scene may differing for audience members based on age or a user input/selection of a version, and a third scene may again be identical for all audience members).

Showing multiple image/data streams concurrently on a display and providing on demand switching at the glasses/filters may be used to provide user-control in a branching story. This would allow guests to choose their own adventure or story by branching the storyline at one or more points or times in the show or entertainment event. The branch points may be cued visually and/or with audio (e.g., display text indicating each audience member or sets of members have to choose a branch such as to follow a particular character, display three doors/paths on the screen and have the audience members choose one, and so on). Another application would be used in a dark ride to allow for the same digitally projected scene to be used by vehicles at different points in the ride (e.g., with each vehicle rider having an optical filter/glasses or the windows or wind shield providing the optical filter that may operate in differing operating states to filter different sets of image streams).

The selection of differing image streams from a plurality of projected images can be used to provide an “overlay” such as to provide optional additional information or context. For example, additional information on a scene or base scene may be provided when a user selects a different image stream by providing the same base scene but with overlays in the form of informational side bars, pop up windows/balloons, and the like that expand on the story, history, or relevance of the displayed images/scene. For example, a museum scene may be displayed (or an image at a museum) where a viewer may choose to get additional information on portions/displays that interest them and would view a different image stream including additional details or “secret” information on that display or exhibit (e.g., one viewer may be very interested in ancient Egypt while another audience member may enjoy dinosaurs and each could individualize the experience by providing user input/selections of video or image streams). Overlays could also be used to provide “Easter Eggs” or items to be found/collected by the audience such as hidden characters/elements only viewable on particular concurrently displayed image streams and only, in some cases, when the switch or selection (e.g., user input in a game) is provided at the appropriate time (or within a certain time period such as by answering a question correctly within a defined answer period). A holiday overlay may also be provided that would allow guests/audience members to see differing versions of a show (or portions of a show/game) based on their preferences and user input, e.g., to view a Christmas version of a show or to instead view a standard version or other themed version (e.g., the dog version or cat version to suit particular pet owners). In other cases, the selecting of image streams may allow for audience members to select and switch between streams with differing subtitles such as to suit a multilingual application, which may be useful in educational settings as well as in entertainment settings.

There may be many methods of using the interactive aspects of the invention to enhance gaming for audiences including techniques to personalize actions, personalize responses, and also personalize rewards. For example, a targeting game may be provided in an interactive theater system. Time stream switching with a trigger pull or other input device may be used to allow an audience member to see when they fire a projectile and whether it hits a target. If the trigger pull timing is not correct, the image stream may not change (e.g., show the target in its original state/form). In contrast, with enough possible views/image streams, misses may be shown to the audience members as going high, low, left, right, and so on. This image stream switching provides immediate reward and feedback on an individual basis. In a capture game, a target for capture (such as a character, an animal, an alien, a ghost, and so on) may be provided in a timed view to allow a short period of time (such as less than about 5 to 10 seconds) of super view (with a target overlay) to spot the target element. If the audience member spots/sees the target element and provides proper user input, they will view an image stream of the element being captured and be awarded points. If not, the image may return to a standard image stream without target elements until a next branching point to a capture image stream or stream with a target element overlay. Practice and repeated viewing of interactive game would likely result in achieving a better individual score.

In gaming, a reward stream may be provided using aspects of the interactive theater system. For example, the system may be configured to provide a special branching reward only viewable by certain parts of the audience such as those that have received a certain score level by that branching point or have answered a specific question correctly. In interactive games, scene changes may be provided based on guest actions to provide dramatic changes and/or transformations to the displayed scene by switching image streams. For example, audience members may cast a spell that turns a summer scene to winter. Again, the user input may take many forms such as using a control device (e.g., nearly any electronic device), a handheld controller that determines user movements, devices that determine movement relevant to their seats, and so on.

The operation of an interactive theater according to embodiments of the invention may allow additional control over experience direction. The system may be operated to provide selective stream push to specific people or groups within an audience. The control system may operate to direct guest actions by selectively changing the image streams presented to subgroups (or all) of the audience to manipulate or achieve a particular outcome or pattern. This may be used to provide an interesting experience, e.g., everyone in the audience may be provided similar directions but the outcomes provided may be different based on their user input/selections and/or based on random or direction image stream switching by operation of the controller system (e.g., system can force outcomes and select particular individuals or sets of audience members to receive/view particular ones of the concurrently displayed/presented image streams).

As discussed, the particular techniques/mechanisms for presenting or providing multiple image streams upon a display surface or screen and for allowing differing audience members to view these images may vary widely to practice the invention. A more important aspect is that the audience members are able to switch or change which stream they are viewing during a display time period or show/game event or activity rather than being rigidly assigned (such as by which glasses they are wearing) a stream at the beginning of the show/event. For example, the device (or projector assembly) for displaying multiple image streams that are interleaved or time multiplexed (and, hence, concurrently displayed as that term is used herein) on a display surface or screen may be configured as taught in U.S. Pat. Appl. Publ. No. 2007/0266412 to Trowbridge et al., which is incorporated herein in its entirety by reference. Similarly, the method and/or mechanisms for allowing viewers to see one of the displayed multiple streams at a time may be as taught in this reference, but with the addition of mechanisms or modifications to allow the operating state (or shuttering frequency) to be switched during the display period (e.g., switching devices operable based on system control signals and/or user input).

In some cases, the optical filters (screens or worn devices such as glasses may provide only a polarized filter when unpowered/unactive. When power is applied and a synchronization signal is sent, the optical filters may shutter between opaque and clear (polarized). This shutter rate can be synchronized with a similarly operating shuttered video projector or similar device in order to “tune in” to one of multiple video feeds/streams. For example, it may be possible to provide up to 6 or more separate video feeds/channels at reasonable quality (though higher numbers may be provided if some degradation in quality is accepted such as allowing some “flicker”), and it is likely that technologies will improve facilitating use of higher shutter rates to enable more video streams/channels to be provided. A controller operated by the guest or a show operator may be used in some embodiments to modify the shutter rate on the optical filter in order to view different streams (e.g., modify the operating state of the optical filter to choose a different one of the streams/feeds).

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed. For example, the interactive theater system may further include mechanisms for awarding prizes or points to individual audience members or to subsets of the audience. Such prizes or point scores may be stored in system memory and reported/displayed to the audience members and/or used to award prizes at the end of an activity or interactive game. The interactive theater embodiments described herein and claimed below provide a number of benefits relative to prior devices including improved interactivity, enhanced game play for large groups, and repeatability to allow a game or show to be presented to a number of audiences with similar results but with each member being able to individually interact/affect the experience. The interactive theater operation provides significant improvements in audience member personalization and personal agency or satisfaction with the interactive experience.

In some embodiments, the filtering of the image streams may be less synchronized or “un-synchronized filtering.” Such operation of the optical filters may be used to allow a viewer to view two streams at once or it may be used to provide a smoother transition from one image stream to another by allowing for a dissolve effect. In practice, of course, the optical filters may be provided with glasses or other worn devices, but other optical filters are envisioned and intended for use by the inventors. Such optical filters, for example, may include a shuttered panel mounted on the seat that a guest or audience member looks through toward a screen or display surface. Such a mounted panel or optical filter may be provided for each viewer or be shared with 2, 3, or more audience members (e.g., in a team/group application). The use of an optical filter screen may be easier to implement in some settings than individual glasses since the screens would not have to be distributed/collected at the beginning/end of the show/display.

We claim:

1. A method for providing differing image streams to members of an audience, comprising:
positioning a plurality of optical filters between members of the audience in a viewing area and a display surface;
providing two or more image streams on the display surface during a display time period, wherein the optical filters operate to transmit a first one of the image streams; and
during the display time period, modifying an operating state of a subset of the optical filters to transmit a second one of the image streams, whereby the members of the audience view the first and second image streams.

2. The method of claim 1, wherein the providing of the image streams comprises operating a set of projectors during the display time period to concurrently project the image streams upon the display surface.

3. The method of claim 2, wherein the set of projectors project onto a set of display areas on the display surface, the display areas at least partially overlapping each other.

4. The method of claim 1, wherein the modifying of the operating state is performed in response to user input from audience members associated with the subset of optical filters.

5. The method of claim 4, wherein the optical filters comprise devices worn by each of the audience members or screens positioned between the audience members and the display surface and wherein the user input comprises manually switching the operating state by operating an operating state selector linked to the worn devices or screens.

6. The method of claim 5, wherein the worn devices comprise shuttered glasses with the operating states corresponding to shuttering frequencies that are synchronized with the providing of the image streams to filter all but one of the image streams.

7. The method of claim 4, further comprising providing a cue to the audience members to provide the user input and with a control system enabling the modifying of the operating states of the optical filters after the providing of the cue.

8. An interactive theater system, comprising:
a plurality of projectors projecting a set of image streams upon a display surface;
optical filters wearable by audience members in an interactive theater, the optical filters being operable in at least two operating states to filter all but one of the image streams; and
operating state controllers associated with each of the optical filters selecting one of the operating states for each of the optical filters, wherein the operating state controllers are independently operable at least once during the projecting of the image streams to change one of the image streams.

9. The system of claim 8, wherein the projectors transmit the image streams at a differing frequencies and wherein the optical filters comprise shuttered glasses operable at shuttering frequencies that are synchronized with the image stream frequencies to affect the filtering of all but one of the image streams.

10. The system of claim 9, wherein the operating state controllers are operable by the audience members to switch between the shuttering frequencies to select the one of the image streams.

11. The system of claim 10, wherein the operating state controllers are operable in response to receipt of a selector enable signal from a system controller that is transmitted to at least a subset of the operating state controllers during the projecting of the image streams.

12. The system of claim 8, wherein the projectors are operable to concurrently display the image streams on a single portion of the display surface.

13. The system of claim 8, further comprising a system controller operable during the projecting of the image streams to transmit a state select signal to a set of the operating state controllers to switch the operating state of associated ones of the optical filters.

14. The system of claim 8, wherein the image streams comprise video images associated with a common storyline and wherein each of the image streams comprises content differing from other ones of the image streams, whereby switching between the images streams allows the audience members to view the differing content.

15. An apparatus for selectively viewing one of a set of image streams concurrently projected on a single display, comprising:
an optical filter operating to view the image streams on the display and transmit one of the image streams through to a user of the optical filter;
a controller provided on the optical filter operating to set an operating state associated with the transmitted one of the image streams; and
a channel selector manually operable by the user of the optical filter to switch the operating state between two or more operating states to allow the user to selectively view each of the image streams.

16. The apparatus of claim 15, wherein the optical filter comprises shuttered glasses with a pair of lenses independently operable at differing shuttering frequencies.

17. The apparatus of claim 16, wherein the operating states correspond to pairs of the shuttering frequencies and wherein the shuttering frequencies are each synchronized with a time multiplexed frequency of one of the concurrently projected image streams.

18. The apparatus of claim 15, wherein the set of image streams are projected on the display for a predetermined duration and wherein the channel selector is operable by the user during the predetermined duration to change the operating state of the optical filter.

19. The apparatus of claim 15, wherein the channel selector is connected to the controller to provide a channel selection signal to set the operating state and to provide power for operating the optical filter to filter all but one of the image streams.

20. The apparatus of claim 15, wherein the channel selector is operable in response to a channel selector enable signal from a control system.
